(19) United States
(12) Patent Application Publication
(10) Pub. No.: US 2004/0041118 A1
(43) Pub. Date: Mar. 4, 2004

(54) Throttle-valve

(76) Inventor: Peter Kohlen, Neu-Anspach (DE)

Correspondence Address: Martin A Farber, 866 United Nations Plaza, New York, NY, 10017, US

(21) Appl. No.: 10/398,551

(22) PCT Filed: Oct. 11, 2001
(86) PCT No.: PCT/DE01/03861

(30) Foreign Application Priority Data
Oct. 12, 2000 (DE) 10050393.4

(51) Int. Cl. F16K 1/22

(52) U.S. Cl. 251/306

(57) ABSTRACT

A throttle-valve assembly (10) having a housing (12) which has a throttle opening through which a gaseous medium (70) can flow in a main flow direction (72) and which has an approximately cylindrical cross section (16), in which a throttle valve (20, 80) which is fastened pivotably on a throttle-valve shaft (18) is arranged in the throttle opening (16), and in which the throttle-valve shaft (18) can be adjusted by an actuator (30) arranged in the housing (12), is to have a throttle valve (20, 80) which has a particularly high degree of strength and a particularly low tendency toward wear. For this purpose, the throttle valve (20, 80) has an at least partially radially encircling, annular first region (60) made of a first material (66) and an approximately circular, radial second region (62) made of a second material (68), the first region (60) at least partially enclosing the second region (62), and the first material (66) of the throttle valve (20, 80) having greater strength than the second material (68) of the throttle valve (20, 80).

The invention relates to a throttle-valve assembly having a housing which has a throttle opening through which a gaseous medium can flow in a main flow direction and which has an approximately cylindrical cross section, in which a throttle valve which is fastened pivotably on a throttle-valve shaft is arranged in the throttle opening, and in which the throttle-valve shaft can be adjusted by an actuator arranged in the housing.

To control the quantity of fresh gas of a motor vehicle, use is generally made of throttle-valve assemblies. Throttle-valve assemblies comprise a housing with a throttle opening and a throttle element arranged in the throttle opening. The throttle element assumes a certain position in the throttle opening to allow through a certain quantity of fresh gas. For this purpose, the throttle element can be activated mechanically or electronically.

Housings of throttle-valve assemblies are usually produced from plastic or from metal. Housings of throttle-valve assemblies that have been manufactured from metal, for example aluminum, can be manufactured in a particularly precise manner and can therefore have particularly low tolerances. Low tolerances are necessary for a throttle-valve assembly, in the region of the throttle valve, particularly when the intention is for the quantity of flow medium passing through the throttle opening of the throttle-valve assembly to be able to be influenced even by a particularly small movement of the throttle valve. In the closed region of the throttle valve, these requirements are also referred to as leakage-air requirements. However, metal housings of throttle-valve assemblies have the disadvantage that, after the housing has been produced, for example by die casting, complicated remachining of the housing is usually necessary. For example, remachining of housings made from aluminum is necessary in order to ensure the functional requirements provided in and on the housing. Functional requirements are, in particular, the throttle opening, the holder for the actuator and gear axis spacings. Precise machining of the bearing seats is also usually necessary, since the correct operating play (bearing clearance) is produced only by the press fit on the needle bearing.

Throttle-valve assembly housings manufactured from plastic have a lower weight than throttle-valve assembly housings which are manufactured essentially from metal, in particular aluminum. Furthermore, plastic, as material, can also be adapted in an especially simple way to a wide variety of geometric configurations of the housing. Moreover, in the case of plastic housings produced by injection molding, inserts, for example bearings for mounting the throttle-valve shaft, can be injected into the housing.

Throttle valves which have, for example, a diameter of up to 90 mm and more have a lower strength than throttle valves which only have a diameter of up to 40 mm, for example. In the case of a throttle valve with a particularly large diameter, significantly more gaseous medium, the so-called leakage air or lost air, therefore passes through the throttle opening in the closed state of the throttle valve than in the case of a throttle valve having a particularly small diameter in comparison thereto. Moreover, the lower strength of a throttle valve having a comparatively large diameter has the effect that the throughput of the gaseous medium through the throttle opening cannot be controlled as precisely as is the case with a throttle valve having a significantly smaller diameter in comparison. Also, throttle valves having a particularly large diameter have more tendency toward wear due to the low degree of strength than throttle valves having a particularly small diameter in comparison thereto.

The invention is therefore based on the object of specifying a throttle-valve assembly of the type mentioned above, the throttle valve of which has a particularly high degree of strength and at the same time a particularly low tendency toward wear.

According to the invention, this object is achieved by virtue of the fact that the throttle valve has an at least partially radially encircling, annular first region made of a first material and an approximately circular, radial second region made of a second material, the first region at least partially enclosing the second region, and the first material of the throttle valve having greater strength than the second material of the throttle valve.

The invention starts from the consideration that a throttle valve which has a particularly high degree of strength and a particularly low tendency toward wear should be additionally reinforced. However, the throttle valve should be able to be produced in standard form for economic reasons. In order, with a particularly low outlay, additionally to stabilize the throttle valve, an additional measure should be sufficient in order to impart the required, additional degree of stiffness to the throttle valve. Calculations have revealed that the throttle valve has a particularly high degree of stiffness if the throttle valve has a first region and a second region, with the first region of the throttle valve being additionally stabilized. For this purpose, the first region of the throttle valve is formed from a first material which is stiffer than the second material of the second region of the throttle valve.

In an advantageous manner, the first region is an outer region and the second region is an inner region. In this case, an outer, first region may, for example, be additionally arranged on the throttle valve. The regions of different strength can be provided in a particularly simple manner by the throttle valve having an outer and an inner region.

The second region is advantageously divided into a circular region and an edge region, with the first region being arranged between the circular region and the edge region of the second region. An approximately annular, first region enables the throttle valve to have a particularly high degree of stiffness even with particularly large diameters, with the edge region of the throttle valve remaining unchanged.

The throttle valve advantageously has a smaller thickness in the first region than in the second region. With a comparatively lower first thickness D1 in the first region and a second thickness D2 in the second region of the throttle valve, starting from the closed position of the throttle valve, the throughput of the gaseous medium through the throttle opening can be influenced even by a small movement of the throttle-valve shaft and therefore of the throttle valve. By this means, a particularly finely graduated control of the quantity of gaseous medium passing through the throttle opening is therefore ensured in a particularly reliable manner.

The first region and the second region of the throttle valve are advantageously formed as a single piece from one material, with the first material of the throttle valve in the first region being compressed material and the second material of the throttle valve in the second region being uncompressed material. Compressed materials usually have a significantly higher strength or stiffness than materials which have not been compressed. In order to impart a higher degree of strength to the first region than to the second region, the first region of the throttle valve is compressed in an additional manufacturing step. In this case, the thickness D1 can be impressed into the throttle valve. By means of an impressing process, a particularly high strength of the first region of the throttle valve can be ensured in a particularly simple and economic manner.

The material of the throttle valve is advantageously metal, in particular aluminum. Aluminum can be machined in a particularly simple manner and can be compressed particularly readily owing to its softness.

The throttle-valve shaft has a slot for fastening the throttle-valve shaft, in which the throttle valve which is pushed through the slot protrudes from the throttle-valve shaft on both sides of the slot, so that a subregion of the throttle valve is enclosed in the slot by the throttle-valve shaft. It has proven advantageous in this case if the first region is interrupted by the subregion. As a result, the throttle valve is firstly secured reliably in the slot of the throttle-valve shaft and nevertheless has a first region of increased strength which reliably ensures that the throttle valve has a particularly long service life.

The advantages obtained by the invention reside in particular in the fact that, by means of by an additional stiffening of the first region of the throttle valve, the throttle valve has a particularly high degree of strength and is particularly unsusceptible toward wear. It is thereby reliably ensured that the characteristic curve of the throttle-valve assembly remains virtually unchanged even with the throttle-valve assembly having a particularly long service life.

An exemplary embodiment of the invention will be explained in greater detail with reference to a drawing, in which:

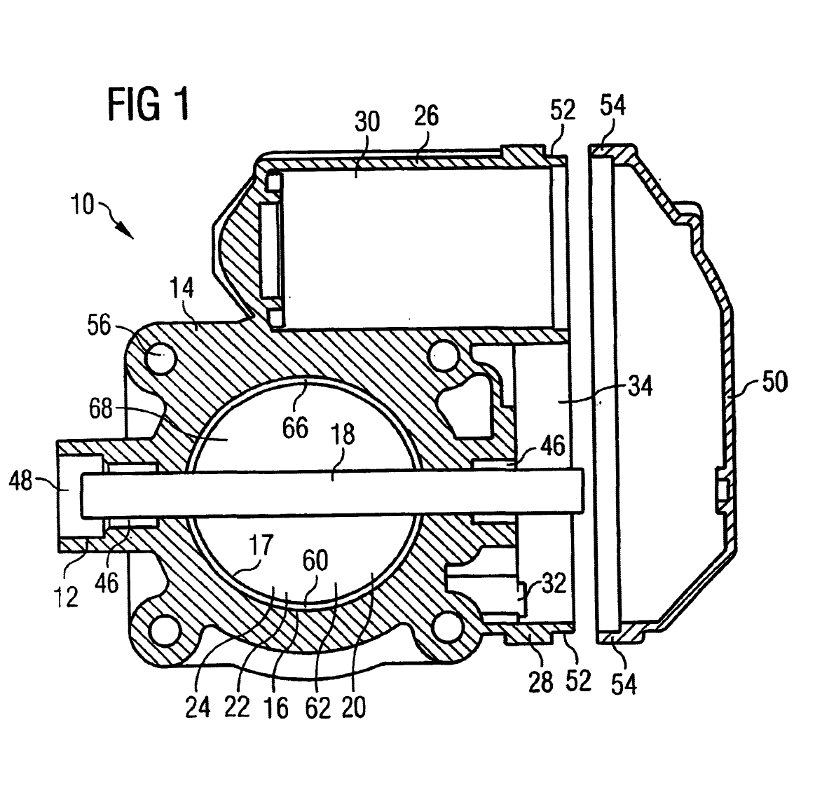

FIG. 1 shows a diagram of a throttle-valve assembly in cross section,

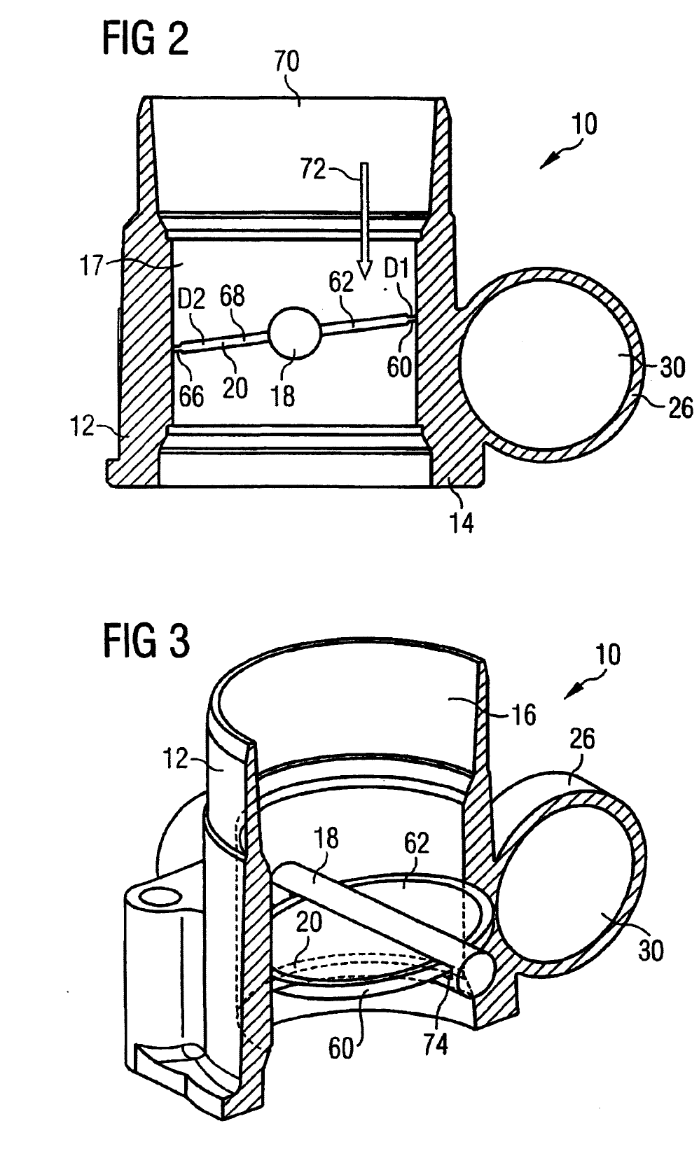

FIG. 2 shows a diagram of the throttle-valve assembly [lacuna] FIG. 1 in longitudinal section,

FIG. 3 shows a diagram of the throttle-valve assembly according to FIG. 1 in longitudinal section in a perspective illustration,

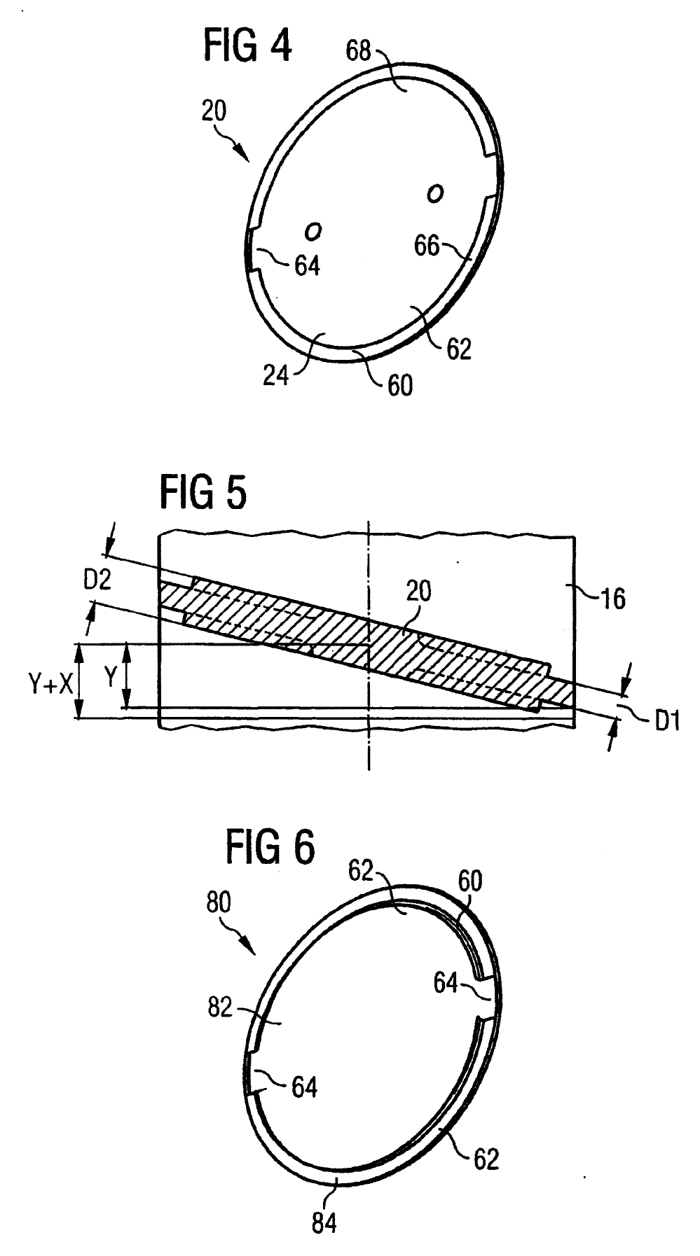

FIG. 4 shows a diagram of a throttle valve according to FIGS. 1, 2 and 3 in a first embodiment,

FIG. 5 shows a diagram of a detail of the throttle-valve assembly according to FIGS. 1, 2 and 3, and

FIG. 6 shows a diagram of a throttle valve in a second embodiment.

Parts corresponding to one another are provided with the same reference numbers in all of the figures.

The throttle-valve assembly 10 according to FIG. 1 is used to feed air or a fuel/air mixture to a consumer (not illustrated), for example an injection device of a motor vehicle (likewise not illustrated), it being possible to control the quantity of fresh gas to be fed to the consumer by means of the throttle-valve assembly 10. For this purpose, the throttle-valve assembly 10 has a housing 12, which is manufactured from metal 14 which, in this exemplary embodiment, is in the form of aluminum. As an alternative, however, the housing 12 may also have been produced from plastic by injection molding. The housing 12 comprises a continuous throttle opening 16 which has an approximately cylindrical cross section 17. Air or a fuel/air mixture can be fed to the consumer (not illustrated) via the throttle opening 16.

To adjust the volume of fresh gas to be fed to the consumer, a throttle valve 20 is arranged on a throttle-valve shaft 18. The throttle valve 20 is manufactured from a material 22 which, in this exemplary embodiment, is in the form of a metal 24. The metal 24, in turn, is aluminum. Rotating the throttle-valve shaft 18 simultaneously pivots the throttle valve 20 arranged on the throttle-valve shaft 18, as a result of which the active cross section of the throttle opening 16 is increased or reduced. The throughput of air or the fuel/air mixture through the throttle opening 16 of the throttle-valve assembly 10 is regulated by means of an increase or decrease in the active cross section of the throttle opening 16 by the throttle valve 20.

The throttle-valve shaft 18 can be connected to a cable pulley (not illustrated specifically), which, in turn, is connected via a Bowden cable to an adjusting device for a power demand. In this context, the adjusting device can be constructed as an accelerator pedal of a motor vehicle, actuation of this adjusting device by the driver of the motor vehicle thus enabling the throttle valve 20 to be moved from a position of minimum opening, in particular a closed position, as far as a position of maximum opening, in particular an open position, in order thereby to control the power output of the motor vehicle.

In contrast, it is possible either for the throttle-valve shaft 18 (shown in FIG. 1) of the throttle-valve assembly 10 to be adjusted by an actuator over part of the range and otherwise by means of the accelerator pedal or for the throttle valve 20 to be adjusted over the entire range of adjustment by an actuator. In these “electronic engine output control” or “drive-by-wire” systems, mechanical power control, for example depressing an accelerator pedal, is converted into an electric signal. This signal, in turn, is fed to a control unit, which produces an activation signal for the actuator. In these systems, there is no mechanical coupling between the accelerator pedal and the throttle valve 20 in normal operation.

To adjust the throttle-valve shaft 18 and hence the throttle valve 20, the throttle-valve assembly 10 therefore has a drive housing 26 and a gear housing 28. The drive housing 26 and the gear housing 28 are formed as a single piece with the housing 12 of the throttle-valve assembly 10, but may also overall form a separate, single-piece constructional unit, or else may each be formed as a single piece by itself. An actuator 30 constructed as an electric motor is arranged in the drive housing 26. Firstly arranged in the gear housing 28 is a position detection device 32 and secondly a gear 34. The position detection device 32 can be used to detect the current position in each case of the throttle-valve shaft 18. The gear 34 is constructed as a reduction gear and is used for transmitting the rotational movement of the actuator 30, which is constructed as an electric motor, to the throttle-valve shaft 18. The position detection device 32 and the gear 34 are not illustrated specifically in the drawing.

The activation of the actuator 30, which is constructed as an electric motor, takes place via a control unit which is likewise not illustrated in the drawing. The control unit transmits to the actuator 30, which is constructed as an electric motor, a signal, by means of which the actuator 30, which is constructed as an electric motor, adjusts the throttle-valve shaft 18 via the gear 34, which is constructed as a reduction gear. The actual position of the throttle-valve shaft 18 is detected via the position detection device 32. The position detection device 32 is constructed for this as a potentiometer, in which the slider of the potentiometer is connected to the throttle-valve shaft 18.

The throttle-valve shaft 18 is mounted in bearings 46 which are arranged on both sides of the throttle opening 16 in the housing 12. The throttle-valve shaft 18 ends on the one side—according to FIG. 1 on the left side—in a space 48 in which, for example, a spring system with so-called return springs and/or emergency-running springs can be accommodated. As an alternative, however, the return springs and/or emergency-running springs may also be accommodated in the region in which the return springs and/or emergency-running springs are arranged. The return springs and/or emergency-running springs of the spring system preload the throttle-valve shaft 18 in the closed direction, with the result that the actuator 30, which is constructed as an electric motor, acts against the force of the return springs and/or emergency-running springs. A so-called return spring and/or emergency-running spring of the spring system has the effect of moving the throttle valve 20 into a defined position if the actuator 30, which is constructed as an electric motor, fails, this position generally being above the idling speed.

As an alternative or in addition, it is also possible for the throttle-valve shaft 18 to project out of the housing 12 of the throttle-valve assembly 10 beyond the space 48. In this case, it is possible, for example, for a cable pulley (not illustrated in the drawing) to be mounted at the end of the throttle-valve shaft 18, said cable pulley being connected to an accelerator pedal via a Bowden cable, thus providing a mechanical desired-value input. This mechanical coupling of the throttle-valve shaft 18 to the accelerator pedal (not illustrated specifically in the drawing) can ensure that the throttle-valve assembly 10 operates in emergency situations, for example if the actuator fails. Furthermore, further attachments may be arranged on the housing 12, said attachments being provided for holding additional elements, such as, for example, stub shafts for gearwheels or segment gears belonging to the gear (not shown), which is constructed as a reduction gear. Further elements of the throttle-valve assembly 10 may also be arranged in the space 48.

The housing 12 of the throttle-valve assembly 10 can be closed by a housing cover 50. For this purpose, the housing 12 of the throttle-valve assembly 10 has a peripheral flat 52 in the direction of the housing cover 50, said flat corresponding to a peripheral web 54 on the housing cover 50. The flat 52 and the web 54 ensure a well defined position of the housing cover 50 on the housing 12. The housing cover 50 is bonded onto the housing 12. As an alternative, however, the housing cover 50 may also be clipped onto the housing 12 or connected permanently to the latter in another way. Furthermore, the housing 12 has flange lugs 56 for connection to elements which are arranged outside the throttle-valve assembly 10 and are constructed as a single piece with the housing 12.

During operation of the throttle-valve assembly 10 the throttle-valve shaft 18 is pivoted by means of the actuator 30, which is constructed as an electric motor. By this means, the throttle valve 20, which is fastened on the throttle-valve shaft 18, releases the throttle opening to a greater or lesser extent, as a result of which the quantity of fresh gas to be fed to the internal combustion engine can be controlled. In order for the throttle valve 20 to have a particularly high degree of strength for this function, the throttle valve 20 is divided into an at least partially approximately annular, first region 60 and an approximately circular, second region 62 and a subregion 64. In this case, the first region 60 at least partially encloses the second region 62.

The first region 60, the second region 62 and the subregion 64 are constructed as a single piece and are manufactured from the material 22 which is in the form of metal 24. In this exemplary embodiment, the metal 24 is aluminum. The first region 60 is manufactured from a first material 66 which is formed as compressed metal 24, i.e. compressed aluminum. The second region 62 is manufactured from a second material 68 which is formed as uncompressed metal 24, i.e. uncompressed aluminum. The first material 66 of the throttle valve 20 is thus stronger than the second material 68 of the throttle valve 20. The subregion 64 is likewise manufactured from the second material 68. The sectional illustration in FIG. 1 means that the subregion 64 cannot be seen.

During production the throttle valve 20 has been cut out of a piece of aluminum, usually with a helix angle with regard to the piece of aluminum. The first region 60 has been subsequently impressed into the throttle valve 20 by means of a pressing process. By this means, the second region 62 and the subregion 64 have uncompressed metal 24 as material 22 and the first region 60 has compressed metal 24 as material 22.

FIG. 2 shows a diagram of a longitudinal section through the throttle-valve assembly 10 according to FIG. 1. A gaseous medium 70 can flow through the continuous throttle opening 16 of the throttle-valve assembly 10 in a main flow direction 72. The quantity of throughput of the gaseous medium 70 through the throttle opening 16 is controlled with the aid of the position of the throttle valve 20. In order for the throttle valve 20 to have a particularly high degree of strength for this, the throttle valve 20 is divided into an at least partially approximately annular, first region 60 made of the first material 66 and an approximately circular, second region 62 made of the second material 68. The first material 66 of the throttle valve 20 is compressed aluminum. The first region 60 of the throttle valve 20 therefore has a smaller thickness D1 than the remaining region 66 of the throttle valve 20, which has a thickness D2. The compressed, first region 60 which is impressed into the throttle valve 20 enables the throttle valve 20 to be particularly unsusceptible to wear.

According to the illustration of the throttle-valve assembly 10 according to FIG. 3, the throttle valve 20 is pushed through a slot 74 in the throttle-valve shaft 18 and protrudes from the throttle-valve shaft 18 on both sides of the slot 74, with the subregion 64 of the throttle valve 20 being enclosed in the slot 74 by the throttle-valve shaft 18. Since the throttle valve 18 in the subregion 64 enclosed by the throttle-valve shaft 18 is usually sufficiently stabilized by the throttle-valve shaft 18, the first region 60, which is manufactured from compressed material 22, is manufactured from uncompressed material 22. The first region 60 is thus interrupted by the subregion 64. In this FIG. 3 too, the subregion 64 is covered by the slot 74 and therefore cannot be seen.

The throttle valve 20 according to FIG. 4 is illustrated as an individual component and corresponds to the throttle valves 20 of FIGS. 1, 2 and 3. It can be seen in this illustration that the subregion 64 of the throttle valve 20, which region is to be arranged in the slot 74 of the throttle-valve shaft 18 during installation of the throttle valve 20, has approximately the same diameter D2 which the remaining, second region 62 of the throttle valve 24 also has.

FIG. 5 shows a diagram of a detail of the throttle-valve assembly 10 according to FIGS. 1 and 2. The smaller thickness D1 of the first region 60 of the throttle valve 20 means that the throttle valve 20 now has, in comparison with a throttle valve without a compressed, first region 60, the property of it being possible to control the throughput of the gaseous medium 70 through the approximately cylindrical throttle opening 16 even with a particularly small movement of the throttle valve 20 from its closed position toward an open position. This is indicated by the line sections Y and X+Y which have been drawn in.

The line section Y runs from the central point of the throttle-valve shaft 18 as far as the point at which the throttle valve 20, with its smaller thickness D1, comes into contact with the wall of the throttle opening 16. The line section X+Y runs from the central point of the throttle-valve shaft 18 as far as the imaginary point at which a throttle valve, which has a thickness D2 throughout, would come into contact with the wall of the throttle opening 16. The throttle valve 20 having the thickness D2 in the first region thus already influences the quantity of gaseous medium passing through the throttle opening 16 in the region of movement of the throttle valve 20 between Y and X+Y, whereas the imaginary throttle valve with the continuous thickness D2 would influence the quantity of gaseous medium passing through the throttle opening only in a region of movement which is larger than X+Y.

The characteristic curve of a throttle-valve assembly 10 having a throttle valve 20 which comprises a first, smaller thickness D1 and a second, larger thickness D2 therefore has a greater working range than the characteristic curve of an imaginary throttle-valve assembly having an imaginary throttle valve which has a thickness D2 throughout. In this case, the characteristic curve of a throttle-valve assembly describes the dependence of the angle of rotation of the throttle-valve shaft on the mass of the gaseous medium which passes through the throttle opening at a certain angle of rotation of the throttle-valve shaft or opening angle of the throttle valve. By this means, the throughput of the gaseous medium 60 through the throttle opening 16 can be controlled more precisely than is the case with a conventional throttle valve.

FIG. 6 shows a diagram of an individual throttle valve 80 which does not correspond to the throttle valves of FIGS. 1, 2, 3, 4 and 5. In the case of the throttle valve 80 according to FIG. 6, the second region 62 is divided into a circular region 82 and an edge region 84, with the first region 60 being arranged between the circular region 82 and the edge region 84 of the second region 62. In this embodiment, the throttle valve 80 has a particularly high degree of strength on account of the first region 60 which is manufactured from a first material 66 which has a greater strength than the second material 68 of the second region 62. The throttle valve 80 here also has a subregion 64 which is composed of the second material 68. A throttle valve of this type can be used, for example, in motor vehicles which require a throttle valve having a particularly large diameter on account of a particularly large throughput of gaseous medium, but in which a particularly fine graduation of the working range of the throttle-valve assembly is not absolutely necessary.

The higher degree of strength which the first region 60 of the throttle valve 20 has in comparison with the second region 62 and the subregion 64 particularly reliably ensures that the throttle valve 20, even with particularly large diameters, shows a particularly low tendency toward wear. In this case, the strength of the edge region 60 of the throttle valve 20 particularly reliably ensures a particularly small degree of leakage air or lost air when the throttle valve 20 assumes its closed position. By means of a simple, additional manufacturing step the throttle valve 20 has a particularly high degree of strength and is therefore particularly unsusceptible toward wear at the same time. This reliably ensures that the characteristic curve of the throttle-valve assembly 10 remains virtually unchanged even when the throttle-valve assembly 10 has a particularly long service life.

1. A throttle-valve assembly (10) having a housing (12) which has a throttle opening (16) through which a gaseous medium (70) can flow in a main flow direction (72) and which has an approximately cylindrical cross section (17), in which a throttle valve (20, 80) which is fastened pivotably on a throttle-valve shaft (18) is arranged in the throttle opening (16), and in which the throttle-valve shaft (18) can be adjusted by an actuator (30) arranged in the housing (12), characterized by the fact that the throttle valve (20, 80) has an at least partially radially encircling, annular first region (60) made of a first material (66) and an approximately circular, radial second region (62) made of a second material (68), the first region (60) at least partially enclosing the second region (62), and the first material (66) of the throttle valve (20, 80) having greater strength than the second material (68) of the throttle valve (20, 80).

2. The throttle-valve assembly (10) as claimed in claim 1, characterized by the fact that the first region (60) is an outer region and the second region (62) is an inner region.

3. The throttle-valve assembly (10) as claimed in claim 1, characterized by the fact that the second region (62) is divided into a circular region (82) and an edge region (84), with the first region (60) being arranged between the circular region (82) and the edge region (84) of the second region (62).

4. The throttle-valve assembly [lacuna] as claimed in one of claims 1 to 3, characterized by the fact that the throttle valve (20, 80) has a smaller thickness in the first region (60) than in the second region (62).

5. The throttle-valve assembly (10) as claimed in one of claims 1 to 4, characterized by the fact that the first region (60) and the second region (62) of the throttle valve (20, 80) are formed as a single piece from one material (22), with, in the first region (60) of the throttle valve (20, 80), the first material (66) being compressed material (22) and, in the second region (62) of the throttle valve (20, 80), the second material (68) being uncompressed material [lacuna].

6. The throttle-valve assembly (10) as claimed in claim 5, characterized by the fact that the material (22) of the throttle valve (20, 80) is metal (24), in particular aluminum.

7. The throttle-valve assembly (10) as claimed in one of claims 1 to 6, in which the throttle-valve shaft (18) has a slot (74) for fastening the throttle valve (20, 80), in which the throttle valve (20, 80) which is pushed through the slot (74) protrudes from the throttle-valve shaft (18) on both sides of the slot (74), so that a subregion (64) of the throttle valve (20, 80) is enclosed in the slot (74) by the throttle-valve shaft (18), characterized by the fact that the first region (60) is interrupted by the subregion (64).
